(19) United States
(12) Patent Application Publication
(10) Pub. No.: US 2016/0004973 A1
(43) Pub. Date: Jan. 7, 2016

(54) BUSINESS TRIZ PROBLEM EXTRACTOR AND SOLVER SYSTEM AND METHOD

(71) Applicants: Hristo Trenkov, Rockville, MD (US); George Ianakiev, Chevy Chase, MD (US)

(72) Inventors: Hristo Trenkov, Rockville, MD (US); George Ianakiev, Chevy Chase, MD (US)

(21) Appl. No.: 14/324,226

(22) Filed: Jul. 6, 2014

(51) Int. Cl. G06N 5/04

(52) U.S. Cl. CPC G06N 5/047

(57) ABSTRACT

A computer-based method to identify and solve problems that exist in a real-world system by cross-functional, cross-industry logic methods and technology-enabled infrastructure to facilitate inventive business problem solving through integrated system and method to (1) extract system problem and formulate TRIZ contradiction inputs, (2) refine the problem statement, (3) search TRIZ business matrix and apply the TRIZ business principles, (4) formulate solutions, (5) apply domain context, (6) generate outputs, and refine the system to enhanced stated for future iterations. More particularly, the present invention allows users to state problems in plain language (English or other), audio, images, video, sensor data, or other information format. The system then analyzes the information and performs semantic information extraction to translate the human-stated problems to Resource Description Framework (RDF) data model ontological subject-predicate-object expressions (triples, in RDF terminology). The problem statement defined in RDF format, is based on the Business TRIZ Engine compatible parameters, which allows general solutions to be determined. These general solutions are augmented with domain-, environmental-, and Organization-specific information to produce domain-specific solutions. Extracted problems and problem solutions are integrated back into the system.

### CROSS REFERENCE TO RELATED PROVISIONAL APPLICATION

This application claims the benefit of U.S. Provisional Patent Application No. 61/843,433 filed on Jul. 7, 2013, the disclosure of which is hereby incorporated herein by reference in its entirety.

### COPYRIGHT NOTICE

Portions of the disclosure of this document contain materials that are subject to copyright protection. The copyright owner has no objection to the facsimile reproduction of the patent document or patent disclosure as it appears in the U.S. Patent and Trademark Office patent files or records solely for use in connection with consideration of the prosecution of this patent application, but otherwise reserves all copyright rights whatsoever.

### FIELD OF THE INVENTION

The present invention generally relates to cross-functional, cross-industry logic methods and technology-enabled infrastructure to facilitate inventive business problem solving through integrated system and method to (1) extract system problem and formulate TRIZ contradiction inputs, (2) refine the problem statement, (3) search TRIZ business matrix and apply the TRIZ business principles, (4) formulate solutions, (5) apply domain context, (6) generate outputs, and refine the system to enhanced stated for future iterations.

More particularly, the present invention allows users to state problems in plain language (English or other), audio, images, video, sensor data, or other information format. The system then analyzes the information and performs semantic information extraction to translate the human-stated problems to Resource Description Framework (RDF) data model ontological subject-predicate-object expressions (triples, in RDF terminology). The problem statement defined in RDF format, is based on the Business TRIZ Engine compatible parameters, which allows general solutions to be determined. These general solutions are augmented with domain-, environmental-, and Organization-specific information to produce domain-specific solutions. Extracted problems and problem solutions are integrated back into the system.

### BACKGROUND OF THE INVENTION

In the former Soviet Union during the 1940's, Genrich Altshuller devised a theory to solve problems encountered in the development of engineered systems. This theory is known as TRIZ, which is the Russian acronym for the Theory of Inventive Problem Solving, and was implemented manually, using books, tables and charts. The TRIZ methodology has been under development in the former Soviet Union by Genrich Altshuller and others since the mid-1940s.

Over the years, significant research around inventive problem solving has taken place with three primary findings emerging:

(1) problem and solution patterns repeat across industries and sciences;

(2) patterns of technical evolution also repeat across industries and sciences, and

(3) technical evolution represented by true innovations adapted scientific effects that occurred first outside the field in which they were subsequently applied.

The TRIZ methodology credits its success to having been built upon the accumulated technological knowledge abstracted from a systematic study of mankind's history of innovation. Genrich Altshuller and others attempted to catalog all human technological knowledge by examining innovative patents issued worldwide. The TRIZ methodology included study of patents to determine the way problems are solved and the innovative steps that lead to inventions.

Through the application of the TRIZ methodology, near-optimal solutions to problems can be developed. The TRIZ methodology, as proposed by Altshuller, offered separate tools (e.g., instruments or techniques) for the solving of technological problems through the resolving of Technical Contradictions (TC). A TC occurs when an improvement in some characteristic of a system results in an undesirable deterioration in some other characteristic.

Tools used according to the TRIZ methodology include Standard Solutions, Principles of Resolving Physical Contradictions, Principles of Eliminating Technical Contradictions, Informational Funds, and Algorithm for Inventive Problem Solving (Russian acronym ARIZ).

The classical TRIZ approach is to disparately apply each tool to the problem, and to later jointly analyze (evaluate) the results of those tools whose application proved successful.

One primary instrument of classical TRIZ methodology was the Table (Matrix) of Technical Contradictions. This two-dimensional table lists on both the X and Y axes the same thirty-nine common characteristics of technological systems, a subset of which are identifiable in virtually all such systems. One axis is labeled improve and the other deteriorate. The TC is found by selecting the two characteristics within the system under consideration that appear contradictory. At the intersection of their row and column on the Table of Technical Contradictions are several numbers. Each of these numbers represents a generalized solution to this contradiction that has been found in the history of technological development to resolve the contradiction. Traditionally, engineers resolve such contradictions by trade-offs, that is, accepting some deterioration in one characteristic to achieve a desired improvement in another. The classical TRIZ solutions seek to resolve such contradictions, not by trade-off, but rather, by improving desired characteristics without any consequent deterioration of other characteristics in the system.

When using classical TRIZ methodology, the process involved is one of using analogies, often distant or far analogies, to relate a generalized solution to the problem in the system under consideration. Often these analogies are to areas of technology entirely unrelated to the expertise of the involved engineer. As a result, the subject matter expert is often not aware of the appropriate analogy to draw upon or does not make the connection between his/her knowledge and the problem under consideration. As a result, subject matter experts in one domain often have difficulty in relating to and benefiting from far analogies occurring at another domain.

The classical TRIZ focuses on physical and engineering problems. The present system invention focuses on business problems based on the TRIZ concepts. In addition, the classical TRIZ methodology has deficiencies—for example, the Business systems may need to be described by characteristics beyond those listed in the initial contradiction matrix. This requires flexible data model that doesn't have pre-defined structure. The present invention is based on an Ontology data model which is non-relational in nature.

Further, in many business systems, particularly complex ones, it is not always apparent what is the real problem that needs to be solved. The underlying or root problem is often masked by other problems, termed sub-problems, that are more apparent. These sub-problems can be solved, but their solution often does not resolve the overall problem situation. In addition, it is often not apparent that the root problem is not being addressed until such sub-problems have been resolved, often at a cost of great time and expense. Classical TRIZ does not provide a methodology for identifying problems that exist in a system and translating them into the TRIZ principles. There is a need for a machine-based system and method to assist users in solving problems in a business system, and in particular, a machine-based system that utilizes concepts of the TRIZ methodology.

Accordingly, there is a need for a method and apparatus that identifies the underlying problems that exist in a system, and providing possible analogous solutions.

### SUMMARY OF THE INVENTION

The present invention is a computer-based method and apparatus for interpreting problems that exist in a system, and identifying (general or specific) solutions. Further, the present invention can assist users in finding solutions to problems that exist in a system.

Typically, the type of systems to which the present invention is applied are those such as engineering environments, technical domain-specific environments, business environments, social environments, behavioral environments, economic environments, political environments, and individual components. Examples of systems include a manufacturing plant, a Next Generation Genome sequencing laboratory, a customer segmentation group, a geographical region, a conflict or area of political interest, a technology product. Note that the above list of system problems is representative and the present invention can be applied to any “systems” in virtually any field of human endeavor and in conjunction with any system where there are problems to be identified and solved.

A typical user of the present invention is an individual contributor of the system, individual who is interested in gaining insight of the behavior of the system under certain conditions, or someone who is interested in influencing the parameters definite the system (hence the system itself).

Commonly, business problem patterns can be found in other non-related domains. Recognizing this provides a basis for solving problems quickly and efficiently. Instead of having to develop a unique business solution, a business solution can be adapted from an extant solution to a problem in another field of human knowledge. The way organizations react to similar problems follows predictable patterns. This presents an opportunity to systematize the development of business solutions when a problem is identified. Business problems can be generalized into parameters for improvement, and specific solutions can be determined from generalized and established business patterns that can be applied towards a wide variety of specific problems.

### BRIEF DESCRIPTION OF THE DRAWINGS

For a fuller understanding of the invention, reference is made to the following description taken in connection with the accompanying drawings in which:

FIG. 1: Depicts the architectural diagram of the invention. There are five main components with 24 sub components. The main components are: (1) Problem Extractor, (2) Business TRIZ Engine, (3) Problem Solver, (4) Data Bank(s) and Ontology, and (5) Tools and Administrative.

FIG. 2: Depicts conceptually the processing chain the present invention uses when deriving business-specific solutions from user input or problem statements derived through autonomous-cognition. The processing chain is broken down based on the three main modules: Problem Extractor (steps 1 through 4), Business TRIZ Engine (step 5), and Problem Solver (steps 6 and 7). Step 8 describes the iterative and self-improving nature of the present invention. Each step represents a discrete processing stage.

FIG. 3: Depicts conceptual view of the Problem Input as per the TRIZ contradiction matrix.

FIG. 4: Depicts conceptual view of the TRIX improvement logic (representative only).

FIG. 5: Depicts conceptual view of the TRIX rules metrics (representative only).

FIG. 6: Depicts conceptual view of the Business TRIX matrix (representative only).

FIG. 7: Depicts the processing chain for the initial setup.

FIG. 8: Depicts the concept—the vertical dotted line separates the public implementation vs. the private implementation.

FIG. 9: Depicts the technical architecture of the invention. Comprised of the following major components: presentation, ontology search, fusion logic, index, store, categorize, discover, and data sources.

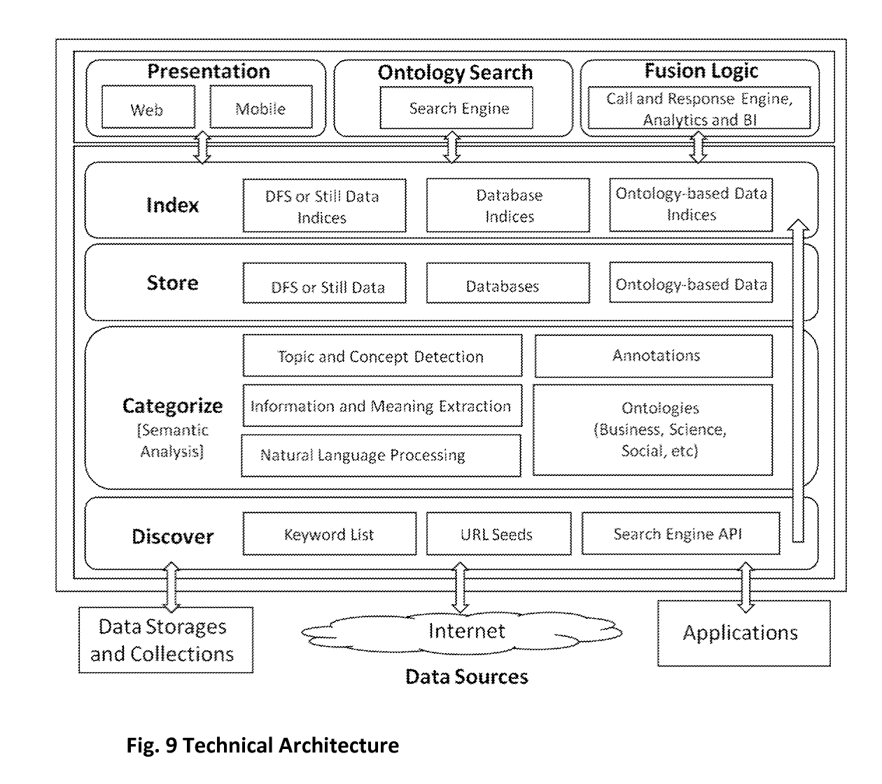

### DETAILED DESCRIPTION OF THE PREFERRED EMBODIMENTS

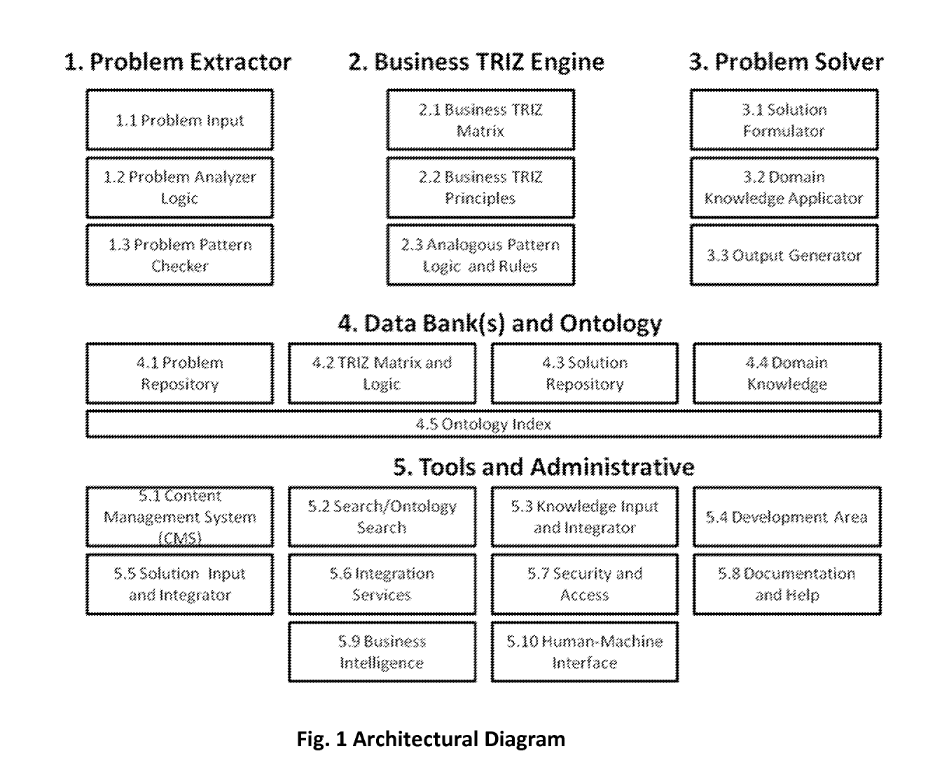

The representative embodiment of the architecture of the present invention is described in FIG. 1.

Problem Extractor.

The representative embodiment of the present invention includes a Problem Extractor. The Problem Extractor uses semantic technologies methods and tools (e.g. Natural Language Processing (NLP), ontology, Reasoner) to formulate the problem(s) of interest in the system. The user enters a description of a system problem under consideration. The description of the system is written in natural language notation, in any language supported by the present invention. The problem is annotated by the present invention into RDF triples (subject-predicate-object expressions). The description of the problem is stored in a memory device in the form of an ontology-based Problem Descriptor. The problem extraction is done based on a pre-defined problem definition “shell” to define improvement and contradictory attributes to the problem statement in the form useful as Business TRIZ Engine inputs.

A Problem Pattern Checker verifies the completeness of the description of the system problem. The present invention analyzes the Descriptor to determine if the Descriptor represents one or more problems in the system under consideration and to determine if the description of the system is logically consistent and complete based on the requirements of the Business TRIZ Engine. As needed, focused questions may be formulated for refinement by the present invention or the user. Additionally, a visual representation of the Descriptor can be displayed to the user on the human-machine interface.

The Problem Extractor can also be used to identify problems in a system. This is referred to as Implicit Cognition or Autonomous-Cognition and is described in other parts of this document.

Business TRIZ Engine.

The present invention forms the basis of a computer-based technological problem solving system. The present invention does not utilize the traditional TRIZ model and ARIZ algorithm, but rather, new problem solving algorithms that are suitable for computer implementation and execution.

Based on the problem parameters, Business TRIZ metrics and principles are applied to identify analogous (generic) solutions. The Business TRIZ matrix is based on thirty-nine (39) by thirty-nine (39) business oriented principles, analogized from the original TRIZ matrix.

Problem Solver.

The representative embodiment of the present invention also includes a Problem Solver. The Problem Solver, at its highest level, is a computer-based apparatus for solving business problems for which a contradiction exists. The user inputs a problem statement with some attributes to be either improved or eliminated, or some function to be implemented (as outlined in the Problem Formulator module). As a result, through this process, the Problem Solver can improve any business, technical or other real world systems.

Generic solutions are produced from the TRIZ matrix. Outputted generic solutions are integrated with domain specific context to identify domain-specific solutions, which are stored into the generic area of the Solution Repository. Generic solutions are corresponded to domain-specific solutions, which are stored into the domain-specific areas of the Solution Repository. Further logic refines the formulated solutions before the output is generated.

In addition, new systems can be synthesized. The Problem Solver of the present invention allows a user to explore the solution “space” in much greater detail and with much more focus. Rather than just consider generalized solutions, which are often highly abstract at best, the present invention provides specific focused recommendations as problem solutions, which can often be immediately implemented. Further, the Problem Solver presents the user with solution analogies that have a significant likelihood of being relevant to the problem under consideration. Often these analogies would not otherwise be obvious or known to the user as they originate from a completely separate business domain.

Data Bank(s) and Ontology.

Four logical or connected physical data repositories exist: (1) Problem Repository, (2) TRIZ Matrix Logic, (3) Solution Repository, and (4) Domain Knowledge. Data Sources are also stored, but are not depicted separately. In one embodiment, the Solution Repository can be deployed in a private instance for the needs of a specific Organization (described in the use cases). In such case, an appliance-based deployment may be preferred.

Tools and Administrative.

Refers to the tools/administrative sub-modules and functions of the present invention.

### Processing Architecture

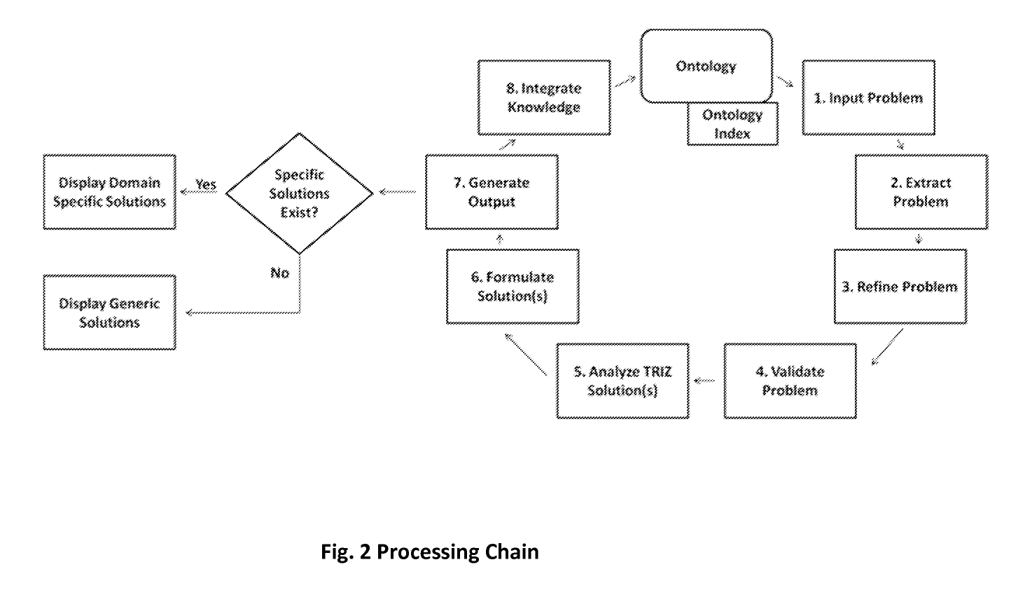

FIG. 2 conceptually depicts the processing chain the present invention uses when deriving business-specific solutions from user input or problem statements derived through autonomous-cognition. The processing chain is broken down based on the three main modules: Problem Extractor (steps 1 through 4), Business TRIZ Engine (step 5), and Problem Solver (steps 6 and 7). Step 8 describes the iterative and self-improving nature of the present invention. Each step represents a discrete processing stage.
1. Input Problem.
The present invention provides a machine-assisted interface for users of the invention to input, into a single field or into separate fields, the system's problem of interest. The knowledge domain or area is defined here.
2. Extract Problem.
Subject matter experts frequently do not understand well the problem at hand and spend their limited resources solving a wrong problem. The Problem Extractor identifies problems in a system by using semantic technologies (e.g. natural language processing (NLP), ontology) to extract problem parameters from the problem statement. This processing step formulates the problem using on RDF triples (subject-predicate-object expressions). The problem extraction is done based on a pre-defined problem definition “shell” to define improvement and contradictory attributes to the problem statement in the form of Business TRIZ engine inputs. This enables the present invention to determine when a problem is well defined or when further refinement is needed. The information extracted from the problem statements is compared and integrated within the Problem Repository of previously defined problems for future needs. Based on the defined RDF triples, the problem statement(s) are translated into TRIZ inputs compatible with the Business TRIZ Engine's contradiction matrix (e.g. decrease work force, and increase productivity). The user stated problem is represented by two contradictory constraints, the TRIZ inputs, and is in the form of two parameters—improve and contradict. For example, Problem Input “I want my business to increase manufacturing productivity by 24% and to reduce work force by 20 persons” will be converted to “increase productivity while reduce workforce”. In this example, the improve (“increase productivity”) and contradict (“reduce workforce”) parameters are defined.
3. Refine Problem.
A Problem Pattern Checker validates the problem formulation after the Problem Extractor and queries for additional knowledge/input related to the problem. The present invention searches for additional supporting internal information within the domain to further characterize the problem. When the Problem Extractor step uncovers gaps in the system problem input, it formulates focused questions for additional input by the user, or by a focused search algorithms.
4. Validate Problem.
This step enables the self-learning and continuous improvement of the problem repository and logic. Once the Problem is extracted completely, this optional user validation step can be performed to confirm whether the problem statement(s) reflect(s) the system problem.
5. Analyze TRIZ Solutions.
The pertinent problem parameters are inputted into the Business TRIZ Engine to identify known generic solutions. The present invention compares the two parameters (improve and contradict) to the Business TRIZ contradiction matrix. The TRIZ contradiction matrix is the predetermined matrix where all improve and contradict parameters are cross-referenced against each other in order to identify applicable TRIZ Business Principles to resolve the two parameters. The Business TRIZ Contradiction matrix leverages the TRIZ Business Principles to identify general analogous solutions to the business problem of interest. As stated earlier, problems tend to appear in patterns with high degree of analogy between business domains (e.g. economics, supply and demand theory, and outthinking intelligent adversary, where similar principles from the economics domain influence the adversarial behavior). The solution to the business problems predictably follows such patterns in a business context. The TRIZ Business Principles in the present invention are adapted from the original engineering principles to general practices businesses or organizations use to resolve contradicting parameters.
The Business TRIZ Engine module of the present invention enables a problem to be solved quickly, efficiently, and comprehensively allowing the Organization and the Subject Matter Experts to focus in areas where true innovation is needed and leverage analogous solutions where they exist.
6. Formulate Solutions.
The problem TRIZ Business principles (from the Problem Extractor) are fed into the TRIZ matrix which pairs the two program-generated parameters (improving and contradicting) to produce a set of analogous solutions. The analogous solutions are derived from already established business practices and principles, as exist in the TRIZ Matrix and Logic. These principles are designed to resolve two contradictory business goals (e.g. increase marketing staff and increase advertisements, all while maintaining current spend levels).
Outputted generic solutions are integrated with domain specific context to identify domain-specific solutions, and stored into the generic area of the Solution Repository. Generic solutions are corresponded to domain-specific solutions, which are stored into the domain-specific areas of the Solution Repository. Domain and environmental/external information are integrated with the generic solutions to produce domain specific solutions. This integration is done by intelligent ontology-driven data model for gathering, integrating and retrieving knowledge. Further logic refines the formulated solutions before the output is generated.
7. Generate Output.
In this machine-assisted interface for user display, outputs are generated into any type of format and media—a report, a decision dashboard, business intelligence, containing all identified solutions to the problem statements. Specific solutions are described in the report if predetermined specific solutions exist. If such a predetermined solution does not exist, then the report returns a generic solution to the user.
In one embodiment, a Report Generator packages the formulated solutions into actionable analysis. In addition, whenever the present invention cannot identify a known solution, then a new solution may be needed. This allows the present invention to be used by subject matter experts as a “predictor” or locator of future inventions.
The program supplements generic parameters with domain-specific information. The Domain Knowledge data repository is used to retrieve domain specifics (as defined in the Data Sources).
8. Integrate Knowledge.
This processing step expands the ontology/data repository with new knowledge. The logical data repositories include: (1) Problem Repository, (2) TRIZ Matrix and Logic, (3) Solution Repository, and (4) Domain Knowledge. In addition, in one embodiment (described in the use cases section further), Solution Repositories can be defined as a Public/Private deployment, where an Organization can choose to deploy a version of the Public Repositories (1 through 4) into a Private instance and augment them with institutional or other paid/proprietary knowledge. Such deployment may require appliance-based deployment architecture.

### Processing Logic

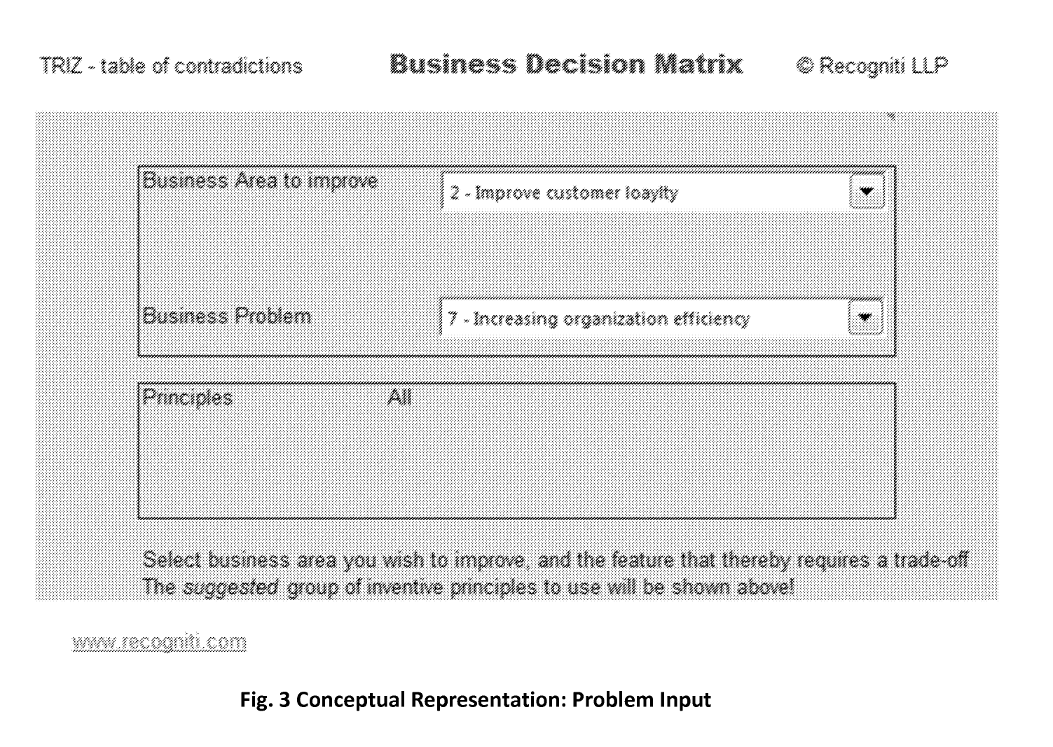

FIG. 3 depicts conceptually the Problem Input:

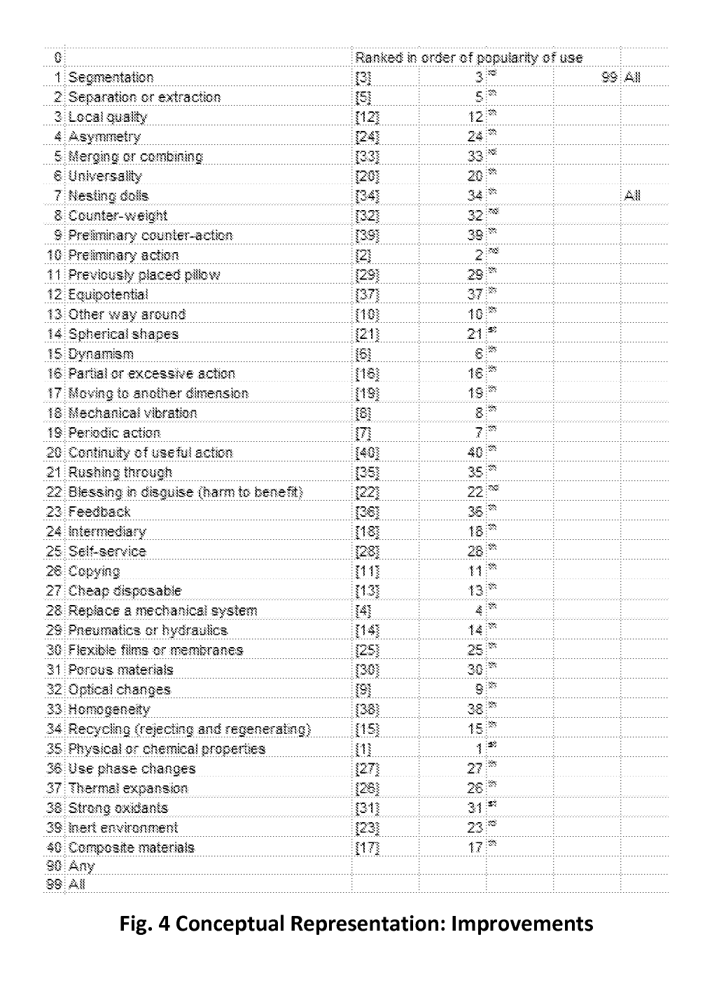

FIG. 4 depicts conceptually the Improvements logic:

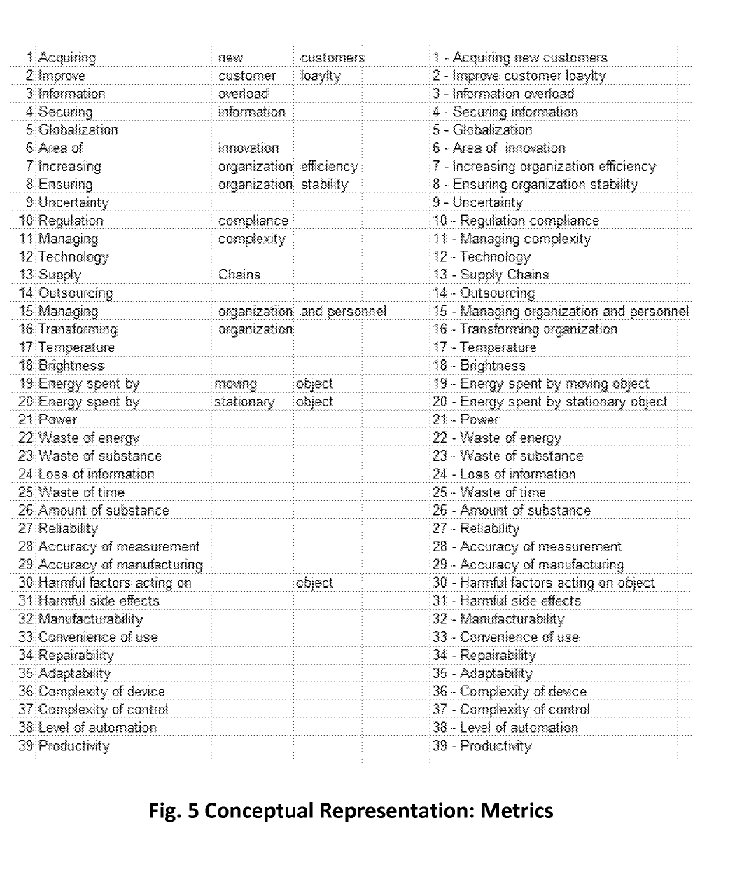

FIG. 5 depicts conceptually the rules metrics:

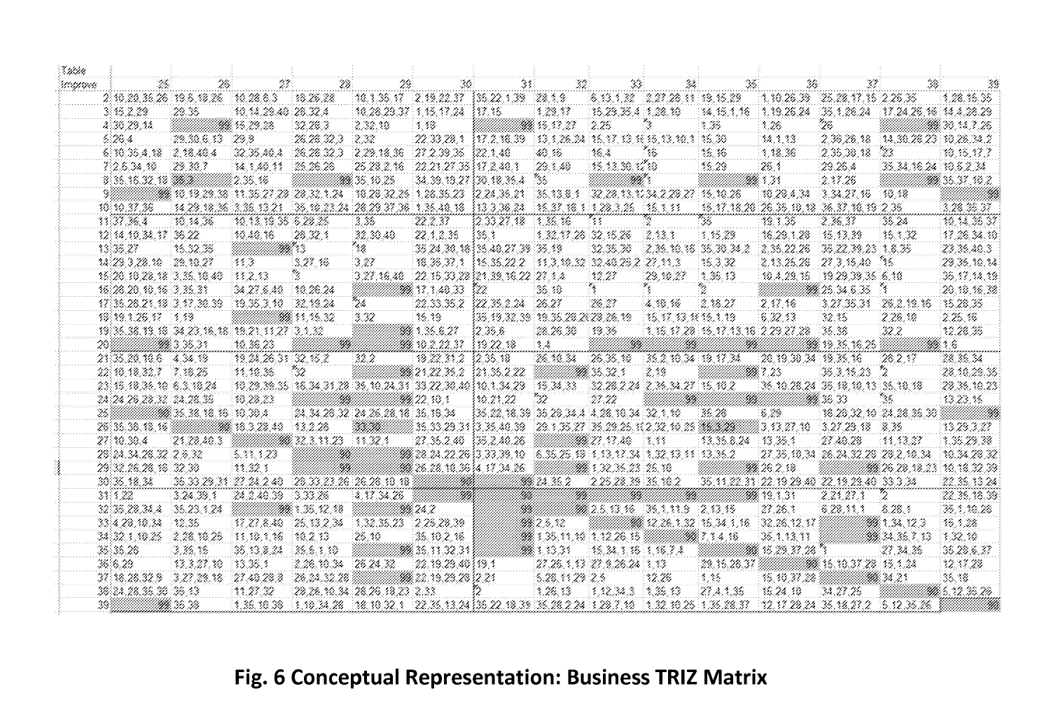

FIG. 6 depicts conceptually the business TRIZ matrix:

### Initial Setup

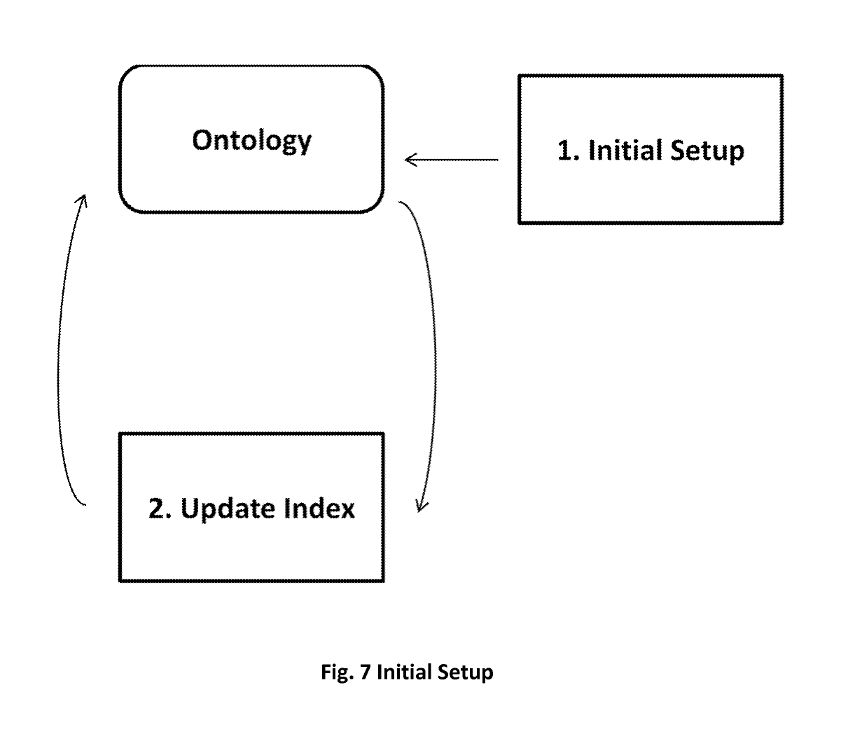

FIG. 7 describes the processing chain for the initial setup.
Ontology.
The ontology is stored in an ontology data bank, which is non-relational in nature. As the present invention integrates additional knowledge about problems, TRIZ logic, solutions and domain knowledge, and context, this may require a schema change in a relational database. Such changes are hard to implement in a relational databases and in a common embodiment, the present invention is implemented based on an ontological data model.
The physical implementation of the ontology data bank of the present invention according to a preferred embodiment is based on an ontology-based data model. A relational or other, non-relational data model can also be used for some embodiments. In both cases, relational or non-relational underlying data model, the processing steps within the application will remain the same after the data model specifics are reflected.
1. Initial Setup.
In this step all initial configuration and setup of the present invention is completed.
2. Update Index.
In this step, the index enabling search and intelligent retrieval of information from the Ontology is updated.

### Case Studies/Examples

This section contains several examples for illustrative purposes of how the present invention can be used. At a high level, the present invention can be used to (1) perform high level analysis and identify analogous solutions that exist in different domains, (2) integrate and retrieve knowledge and perform adaptive classification, integration and retrieval of problem patterns and analogous solutions cross various business domains, and (3) synthesize new systems and “predict” (or locate) inventions, by identifying problem areas that do not have known solutions in a specific domain.

The following case studies are representative embodiments of the present invention.

### Case Study 1: Business Contradiction

This example describes a marketing contradiction challenge that a Technology Organization is facing. It is referred to the steps described in FIG. 2 Processing Chain (above).

Step 1: Input Problem.

Adam is a marketing manager in a technology products Organization. He is faced with the following problem: due to budget cuts, he is forced to either limit his marketing team, thereby reducing the quality of the exhibitions, or maintain the size of his marketing team, thereby reducing the number of exhibitions the team can attend, which leads to reducing the exposure of the company. Adam inputs his problem statements into the Problem Extractor module of the present invention. As an improvement problem statement, he enters “more marketing to be done by my staff and to augment my staff.” As a contradiction problem statement, Adam enters “increase the quality of my marketing material and reduce resources needed.”

Step 2: Extract Problem.

The TRIZ program, using semantic technologies (e.g. natural language processing (NLP), ontology), identifies the descriptive information in the problem statements and extracts the problem attributes. The present invention matches the above problem statements to the TRIZ parameters of “amount of advertisements,” “brand recognition/appeal,” and “productivity” as the improvement parameters and “lower cost” and “response to customer preferences” as the problem attributes.

Step 3: Refine Problem.

If a gap is identified, the present invention can ask Adam focused question to refine the problem statements. Adam described the problem statement completely, so this step is not triggered.

Step 4: Validate Problem.

This is an optional, non-system step. The present invention displays the problem attributes to Adam for validation. The parameters are “amount of advertisements,” “brand recognition/appeal,” “productivity,” “lower cost,” and “response to customer preferences.” Adam, for example, selects “amount of advertisements” and “lower cost” as very important parameters, “brand recognition/appeal” and “productivity” as moderately important parameters, and “response to customer preferences” as not important to him. The present invention then acts concurrently with Adam's preferences.

Step 5: Analyze TRIZ Solution.

The problem parameters are inputted into the TRIZ matrix and subsequently generic solutions are identified. The present invention outputs the generic solutions “Curvature or directness,” “Cheap disposables,” “Local quality,” “Periodic actions,” and “Preliminary actions.”

Step 6: Formulate Solution(s).

The Problem Solver module of the present invention, based on integrated domain knowledge and context, further refines the solution set into a domain-specific solutions. Key attributes about the business of the Organization are leveraged to produce the domain-specific solutions—“marketing directly to customers as opposed to through middlemen,” “hire temporary specialists to develop a higher quality product,” and “start planning projects much further in advance.” Note that if Adam worked for, as an illustration, a pharmaceutical Organization, some of these solutions (such as hiring temporary specialists) may not be relevant.

Step 7: Generate Output.

The present invention, for example, produces a report to Adam with the possible solutions. Adam is then able to further analyze and assess each solution and formulate response strategy and actions.

Step 8: Integrate Knowledge.

This is a system step during which the present invention integrates the knowledge gathered to respond to Adam's problem. This enhances the ability of the present invention to (1) Extract Problems, (2) Perform Business TRIZ-based analysis and (3) Solve Problems for subsequent problems more accurately.

### Case Study 2: Ontology-Based Search Engine

The present invention can be deployed as a platform to index, search, retrieve, filter, integrate and serve information. For business and science domains, innovative architectures, systems and methods for Ontology-based Call and Response Search Engine for Business and Science can be utilized. Traditional search engines (such as Google, Bing, Yahoo) utilize keywords as a main mechanism to search information. It is common that the keyword-based search misses highly relevant data and returns a lot of irrelevant data, since the keyword-based search is ignorant of the type of resources that have been searched and the semantic relationships between the resources and keywords. In order to effectively retrieve the most relevant top-k resources in searching in the Semantic Web, some approaches include ranking models using the ontology which presents the meaning of resources and the relationships among them. This ensures effective and accurate data retrieval from the ontology data repository.

In one embodiment, the Ontology-based Search Engine is deployed with appliance-based federated architecture.

The representative embodiment of the present invention is described below:

Problem Extractor.

In the representative embodiment, the present invention is deployed on a website (public or private). Much like with Google, the user enters search criteria in a free-text natural language notation in English or any other supported language. Information Extraction algorithms and other semantic technologies (e.g. Natural Language Processing (NLP), Ontology, Reasoner, RDF) are used to identify what the user is looking for. This is augmented by the user's specific profile, such as behavior, location, segmentation, or other purposeful attributes. The Problem Extractor defines the Problem Descriptor, which is a coherent description of the search concept of interest.

In addition, search criteria is seamlessly integrated into the underlying ontology-based data model, which makes the search engine “smarter” and more accurate over time.

TRIZ Engine.

The underlying Business TRIZ matrix in this embodiment is used predominantly to classify and contextualize the problem Descriptor and match it with relevant answers. Pattern based algorithms, meta knowledge, and logic are indexed and constantly improved and augmented with new data assets (for example, from Google index, social media data integrator, news aggregator, patent office data, and any other data source). Data types can be text, image, audio, video, locator, sensor, and any other created or detected structured or unstructured information. The present invention integrates into the underlying ontology data model knowledge, meta knowledge and logic continuously based on the user searches, and over time becomes “smarter” and more accurate.

Problem Solver.

In this representative embodiment, the search request is received, and the Problem Solver searches the underlying ontology-data index and retrieves relevant and context-informed answers. The human-machine interface presents the answers back to the user.

The Problem Solver constantly integrates additional data into the index of the underlying ontology-based data model from sources, such as Google index, social media data integrator, news aggregator, patent office data, and any other data source (as specified in the Data Sources). This makes the Problem Solver “smarter” and more accurate over time.

Data Bank(s) and Ontology.

The data model of this representative embodiment consists of four logical or connected physical data repositories: (1) Problem Repository (or Query Repository), (2) TRIZ Matrix Logic (or TRIZ Index), (3) Solution Repository (or Answers Repository), and (4) Domain Knowledge (or Context and Concept Repository). In one embodiment, these repositories are implemented in a single physical ontology-based data model. In another embodiment, the data repositories can be deployed in physically separated machines and an appliance-based approach may be preferred. Irrespective of the deployment of the present invention, the Ontology and Ontology Index are constantly updated as part of the normal operations of the present embodiment.

Example Business TRIZ Ontology is represented as follows:

```
OntologyTRIZ consistsOfPrinciples
      Business_Principle_1
      Business_Principle _2
      Business_Principle _3
      . . .
      Business_Principle _39
ImpromevementsDimension
      Rank
MetricDimension
      Principle_1
      Principle_2
      Factor
Matrix
      Principle_1
      Principle_2
      Improve_Rank
```

### Case Study 3: Business Management

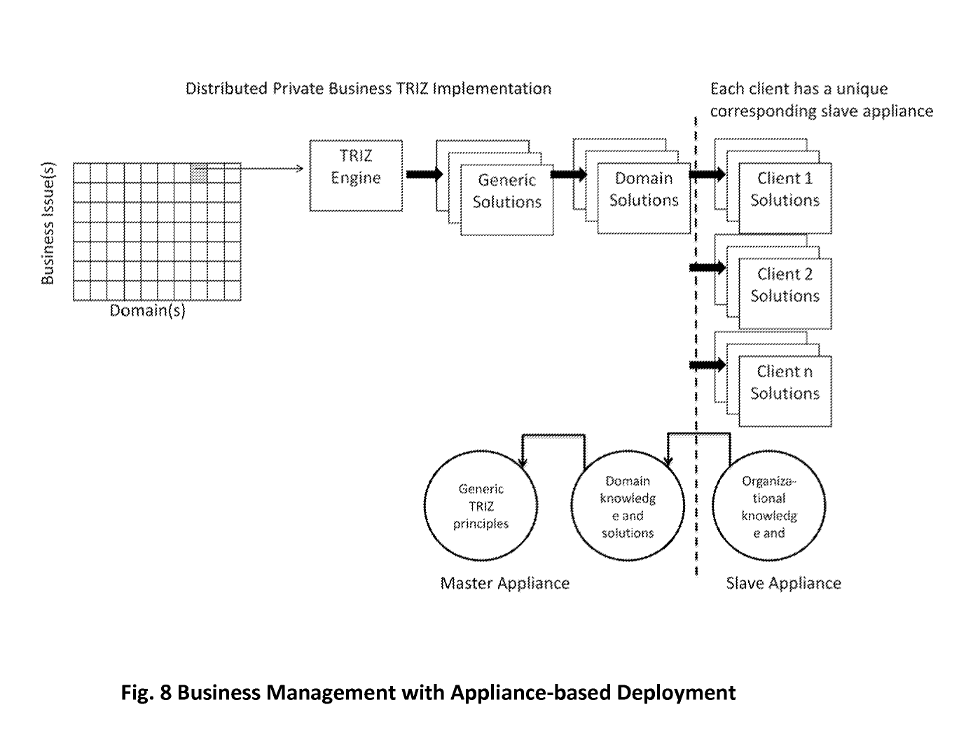

This case study refers to an existing innovation, known as Orchestrated Logic Fusion and Data Fabric Architecture, system and method. The objective of the Organization in this use case is to leverage the present invention when implemented in a universal way (i.e. public, non-Organizational specific) and deploying it in an Organizational specific way (i.e. private). This is similar to how Google search engine can be implemented behind the firewall to index proprietary to an Organization data, while using the public algorithms. FIG. 8 describes the concept—the vertical dotted line separates the public implementation vs. the private implementation.

The Problem Extractor formulates the problem statement—by business problem type (pattern) and domain. The TRIZ Engine produces general solutions, which are turned into domain-specific solutions (if they exist) based on domain context and knowledge.

In one embodiment, the Organization needs to enhance or supplement the domain knowledge and context with proprietary data, knowledge and analysis. This presents the need for synchronization and coordination of the data repositories of the present invention. As stated earlier, the logical data repositories include: (1) Problem Repository, (2) TRIZ Matrix and Logic, (3) Solution Repository, and (4) Domain Knowledge. In the specific embodiment described in this use case, Solution Repositories require a Public/Private deployment, where the Organization deploys a version of the Public Repositories (1 through 4) into a Private instance and augments them with institutional or other paid/proprietary knowledge.

This creates a deployment scenario where the public data repositories act as Master and the Organizational Private repository act as Slave. Slaves are provisioned and managed by the Master. In one embodiment, this is implanted as an appliance-based architecture.

Two specific examples further illustrate this case study:

### Example 1

An Alaska post office uses airplanes to distribute mail because of a lack of roads to provincial areas. The organization-specific geography sets restrictions on the possible domain solutions, which forces the TRIZ system to label several solutions that would be pertinent in other cases as extraneous.

### Example 2

A hospital seeks to optimize its treatment resources. The slave appliance gathers data on local weather patterns, eating habits, demographic information, traffic accident rates, pollution, etc. to determine the health risks of a locality. This information is used to determine appropriate organization-specific solutions.

### CONOPS (Concept of Operations)

In one embodiment, two main deployment concepts exist: Crowd Model: In this concept of operations, the present invention is deployed as a public website (such as Facebook, LinkedIn, Google, Bing, or Yahoo). Users can access the website and much like with Google, submit a free-form text describing their problem. In English or any other supported by the present invention language. The three modules of the present invention:

Problem Extractor.

As users input problems, the ontology and logic of the present invention will become “smarter” and accuracy will increase. This in turn will create a positive use-spiral and more users will be attracted.

TRIZ Engine.

As more problem patterns and business knowledge is incorporated, more accurately the present invention will be able to integrate and retrieve problem, solution and domain knowledge into the ontology-data model. This will result in the present invention becoming “smarter” and more accurate, which in turn will create a positive use-spiral and more users will be attracted.

Problem Solver.

As more solutions are integrated (based on the accumulated knowledge of the Problem Extractor and the TRIZ Engine), the solution related ontology and logic of the present invention will become “smarter” and accuracy in constructing solutions will increase. Once again, this in turn will create a positive use-spiral and more users will be attracted to use the present invention.

Proprietary Model:

This model is similar to the Crowd Model described above with the exception that the present invention is deployed within the perimeter of an Organization (similar to Google search within an Organization) or through a paid access. The three modules of the present invention operate the same way as described in the Crowd model.

### Data Model

The base ontology is described in terms of classes, object properties and data properties. The data model is business problem and domain agnostic. The data schema contains elements that are independent of the details of any specific problem and a solution that it is applied to. Furthermore, the processing steps within the application will remain the same after the data model specifics are reflected.

The data model is captured in the base ontology. Additional classes and properties might be required to meet the needs of a specific business application.

### Deployment Architecture

The present invention can be deployed (1) as a stand-alone deployment, (2) on a cloud-based infrastructure based on a framework supporting data-intensive distributed applications such as, for example, HADOOP, or (3) as an appliance-based architecture.

### Technical Specifications

Technical architecture is comprised of several components:

Hardware:

Operating System:

Using a 64-bit operating system helps to avoid constraining the amount of memory that can be used on worker nodes. For example, 64-bit Red Hat Enterprise Linux 6.1 or greater is often preferred, due to better ecosystem support, more comprehensive functionality for components such as RAID controllers.

Computation:

Computational (or processing) capacity is determined by the aggregate number of Map/Reduce slots available across all nodes in a cluster. Map/Reduce slots are configured on a per-server basis. I/O performance issues can arise from sub-optimal disk-to-core ratios (too many slots and too few disks). Hyper Threading improves process scheduling, allowing you to configure more Map/Reduce slots.

Memory:

Depending on the application, your system's memory requirements will vary. They differ between the management services and the worker services. For the worker services, sufficient memory is needed to manage the Task Tracker and Fileserver services in addition to the sum of all the memory assigned to each of the Map/Reduce slots. If you have a memory-bound Map/Reduce Job, you may need to increase the amount of memory on all the nodes running worker services. When increasing memory, you should always populate all the memory channels available to ensure optimum performance.

Storage:

A Big Data platform that's designed to achieve performance and scalability by moving the compute activity to the data is preferable. Using this approach, jobs are distributed to nodes close to the associated data, and tasks are run against data on local disks. Data storage requirements for the worker nodes may be best met by direct attached storage (DAS) in a Just a Bunch of Disks (JBOD) configuration and not as DAS with RAID or Network Attached Storage (NAS).

Capacity:

The number of disks and their corresponding storage capacity determines the total amount of the Fileserver storage capacity for your cluster. Large Form Factor (3.5″) disks cost less and store more, compared to Small Form Factor disks. A number of block copies should be available to provide redundancy. The more disks you have, the less likely it is that you will have multiple tasks accessing a given disk at the same time. More tasks will be able to run against node-local data, as well.

Network:

Configuring only a single Top of Rack (TOR) switch per rack introduces a single point of failure for each rack. In a multi-rack system, such a failure will result in a flood of network traffic as Hadoop rebalances storage. In a single-rack system, this type of failure can bring down the whole cluster. Configuring two TOR switches per rack provides better redundancy, especially if link aggregation is configured between the switches. This way, if either switch fails, the servers will still have full network functionality. Not all switches have the ability to do link aggregation from individual servers to multiple switches. Incorporating dual power supplies for the switches can also help mitigate failures.

Software:
Hadoop—
Hadoop is a project from the Apache Software Foundation written in Java to support data intensive distributed applications. Hadoop is an umbrella of sub-project around distributed computing.
Core:
The Hadoop core consists of a set of components and interfaces that provide access to the distributed file system and general I/O (Serialization, Java RPC, Persistent data structures. The core components also provide “Rack Awareness”, an optimization which takes into account the geographic clustering of servers, minimizing network traffic between servers in different geographic clusters.
Map Reduce:
Hadoop Map Reduce is a programming model and software framework for writing applications that rapidly process vast amounts of data in parallel on large clusters of computer nodes.
HDFS:
Hadoop Distributed File System (HDFS) is the primary storage system used by Hadoop applications.
HBase:
HBase is a distributed, column-oriented database. HBase uses HDFS for its underlying storage. It supports batch style computations using MapReduce and point queries (random reads). HBase is used in Hadoop when random, real-time read/write access is needed.
Pig:
Pig is a platform for analyzing large data sets. It consists of a high-level language for expressing data analysis programs, coupled with infrastructure for evaluating these programs.
ZooKeeper:
ZooKeeper is a high-performance coordination service for distributed applications. ZooKeeper centralizes the services for maintaining the configuration information, naming, as well as providing distributed synchronization, and group services.
Hive:
Hive is a data warehouse infrastructure built on top of Hadoop. Hive provides tools to enable easy data summarization, ad-hoc querying and analysis of large datasets stored in Hadoop files. It provides a mechanism to put structure on this data using a simple query language called Hive QL.
Chukwa:
Chukwa is a data collection system for monitoring large distributed systems.
Semantic Web—
Semantic Web provides a back structure to the information by describing and linking data to establish context or semantics that adhere to defined grammar and language constructs. The structures are semantic annotations that conform to a specification of the intended meaning.
The Resource Description Framework (RDF)—
RDF consists of a family of W3C metadata specifications used now as a general method for conceptual description or modeling of information.
Web Ontology Language (OWL)—
The OWL extends the RDF vocabulary with additional resources that can be used to build more expressive ontologies.

What is claimed is:

1. A computer-based method to identify and solve problems that exist in a real-world system, the method comprising the steps of:
i. receiving as input a description of the real-world system in natural language according to a predetermined syntax;
ii. extract system problem and formulate TRIZ contradiction inputs;
iii. refine the problem statement(s)
iv. each said problem statement identifying a problem pattern that exists in the real-world system;
v. search TRIZ business matrix and apply the TRIZ business principles;
vi. formulate solutions;
vii. apply domain context;
viii. generate signaling output(s) of formulated solutions;
ix. refine the method to enhanced state for future iterations
x. one or more computers with server functions for holding the described information.

2. The method of claim 1 further described of the processing step to allow operator to find said solutions to the said problems;

3. The method of claim 1 wherein the said real-world system is one of engineering environments, technical domain-specific environments, business environments, social environments, behavioral environments, economic environments, political environments, and individual components;

4. The method of claim 1 wherein the said problem pattern can be found in other non-related real world systems;

5. The method of claim 1 further described by an architecture comprised of the following: problem extractor, business TRIZ engine, problem solver, data bank(s) and ontology, tools and administrative;

6. The method of claim 5 wherein the said problem extractor is further comprised of processing steps using semantic technologies methods and tools to formulate the problem(s) of interest in the system;

7. The method of claim 5 wherein the said problem extractor annotates description of a real-world system into RDF triples—subject-predicate-object expressions;

8. The method of claim 7 wherein the said description of a real-world system is stored in a memory device in the form of an ontology-based problem descriptor;

9. The method of claim 5 wherein the said business TRIZ engine is further comprised of steps for problem solving algorithms based on business TRIZ metrics and principles applied to identify analogous (generic) solutions;

10. The method of claim 9 wherein the said business TRIZ is based on thirty-nine (39) by thirty-nine (39) business oriented principles, analogized from the original TRIZ matrix;

11. The method of claim 5 wherein the said problem solver is further comprised of steps for solving business problems for which a contradiction exists;

12. The method of claim 5 wherein the said data bank(s) and ontology is further comprised of four logical or physical repositories: Problem Repository, TRIZ Matrix Logic, (Solution Repository, and Domain Knowledge;

13. The method of claim 1 wherein the real-world system is a description of a business or science domain;

14. The method of claim 13 further comprising of processing steps for ontology-based search engine;

15. The method of claim 13 further comprising of processing steps for Orchestrated Logic Fusion and Data Fabric Architecture;

16. The method of claim 1 further comprising of processing steps for describing the real-world system in a crowd mode;

17. The method of claim 16 wherein the said crowd sourcing is comprised of processing steps for descriptions of real-world systems to be integrated into the data bank(s) and ontology;

18. The method of claim 1 further comprising the step of outputting the said formulated solution to an operator;

19. The computer-based method of claim 1 wherein the real-world system is a product;

20. The computer-based method of claim 1 wherein the real-world system is knowledge;

21-80. (canceled)
